(19) United States
(12) Patent Application Publication
(10) Pub. No.: US 2005/0055869 A1
(43) Pub. Date: Mar. 17, 2005

(54) Fishing apparatus

(76) Inventors: A. J. Corso, Friendswood, TX (US); Mark Arnold, Spring, TX (US)

Correspondence Address: STREETS & STEELE, 13831 NORTHWEST FREEWAY, SUITE 355, HOUSTON, TX, 77040, US

(21) Appl. No.: 10/660,311

(22) Filed: Sep. 11, 2003

(51) Int. Cl. A01K 97/00

(52) U.S. Cl. 43/54.1

(57) ABSTRACT

A fishing apparatus having particular utility in wade fishing includes a buoyant, board-like support member, a fish container secured to the support member for holding fish caught by the user, and a first bait container also secured to the support member for storing bait such as live bait. Other features of the fishing apparatus include a second bait container for storing bait such as fishing lures and tubular containers for supporting fishing rods and a landing net.

### BACKGROUND OF THE INVENTION

1. Field of the Invention

The present invention relates to fishing apparatuses, and, more particularly, apparatuses for use in wade fishing.

2. Background of the Related Art

Fishing is an activity having both commercial and sporting purposes. It is highly popular as an outdoor sport, largely because of the solitude (or companionship) and opportunity to enjoy fresh air and natural scenic beauty. Of course, the successful angler can also look forward to a tasty meal.

Fishing participants typically go out in boats loaded with a wide variety of fishing gear. Such gear may include heavy tackle boxes containing the latest lures, live bait containers, multiple fishing poles, and one or more landing nets. While many persons who outfit themselves in this way find fishing to be practical only with a boat, others prefer the solitude and intimacy found only in wade fishing. A need therefore exists for a means of conveniently transporting the above-mentioned fishing gear to the fishing site, and having such gear available for easy access and use while wade fishing (i.e., without the need for a boat).

Wade fishing can be very peaceful and relaxing. Those who wade fish often wade for hours, over distances that cover more than a mile, in fishing sites such as a bay among pylons or in the surf along the shore. Wade fishing allows one to get closer to the quarry than by a boat, simply because of the lower profile presented when half of one's body is below the water. By its very nature, however, it's only a matter of time before some of those engaged in wade fishing will find the rest of their body going below the water due to stepping over a drop-off or within a hole. A need therefore exists for a grippable buoyant device that a person may use to pull himself or herself out of such a submerged position while wade fishing.

### SUMMARY OF THE INVENTION

The present invention provides a fishing apparatus that includes a buoyant board-like support member, a fish container secured to the support member for holding fish, and a first bait container secured to the support member for storing bait.

In a preferred embodiment of the present invention, the support member has a securing aperture therethrough for tethering to a user. In an alternative embodiment, the support member has a cleat mounted thereon for tethering to a user. The present invention therefore contemplates, and includes in at least one embodiment, a tether secured at or near one of its ends to the support member. The tether is adapted for being securing at or near the other of its ends to a user.

The support member is preferably filled with an expanded polystyrene material, which provides buoyancy. In a particular embodiment, the support member has at least one—and preferably four—gripping indentation(s) provided therein. In alternative embodiments, the support member includes at least one—and preferably four—gripping aperture(s) therethrough. It is further preferred that the support member have a fluorescent outer surface for enhanced visibility. With these characteristics, the inventive fishing apparatus may serve as an effective life saver, among other things.

In a preferred embodiment, the support member of the fishing apparatus is equipped for measuring the length of fish caught while fishing. It is also preferred that at least one, and more preferably a plurality, of gear containers be secured to the support member. Each of the gear containers has a generally tubular shape for supporting elongated fishing gear. It is further preferred that a utility bar having a plurality of storage apertures therethrough for receiving fishing gear, such as hand tools, is secured to the support member. In a particularly preferred embodiment, the fishing apparatus is equipped with at least three gear containers that extend upright from the upper surface of the support member, and the utility bar is connected across the three gear containers at an elevation above the upper surface of the support member. An optional feature of the fishing apparatus is a rudder affixed to the support member for stability while fishing.

In a preferred embodiment, the support member has a fish-holding aperture sized and shaped to receive the fish container therethrough, whereby a portion of the fish container extends downwardly beneath the support member. The fish container is preferably a generally tubular-shaped net that permits the submergence of fish disposed therein while fishing. The net preferably has a mouth that is adjustable between an open configuration and a closed configuration.

In the preferred embodiment, the support member also has a bait-holding aperture sized and shaped to receive the first bait container therethrough, whereby a portion of the first bait container extends downwardly beneath the support member. The first bait container is preferably adapted for holding live bait, and may be constructed of plastic in a substantially cylindrical shape having an openable lid.

It is further preferred that the inventive fishing apparatus include a second bait container adapted for holding artificial bait. The second bait container is preferably secured to the upper surface of the support member and includes at least one plastic box having an openable lid and a plurality of bait-holding compartments. In a particularly preferred embodiment, the second bait container is secured to the upper surface of the support member and includes a plurality of stacked plastic boxes each having an openable lid and a plurality of bait-holding compartments.

### BRIEF DESCRIPTION OF THE DRAWINGS

Various aspects and embodiments of the present invention are illustrated in the appended drawings. It is to be noted, however, that the appended drawings illustrate only typical embodiments of the invention and are therefore not to be considered limiting of its scope, for the invention may encompass other equally effective embodiments.

FIG. 1 is a perspective view of a fishing apparatus in accordance with the present invention.

FIG. 2 is a side elevational view of the fishing apparatus of FIG. 1.

FIG. 3 is a plan view of the fishing apparatus of FIG. 1.

FIG. 4 is a perspective view of the fishing apparatus having alternative features.

### DETAILED DESCRIPTION OF THE PREFERRED EMBODIMENT(S)

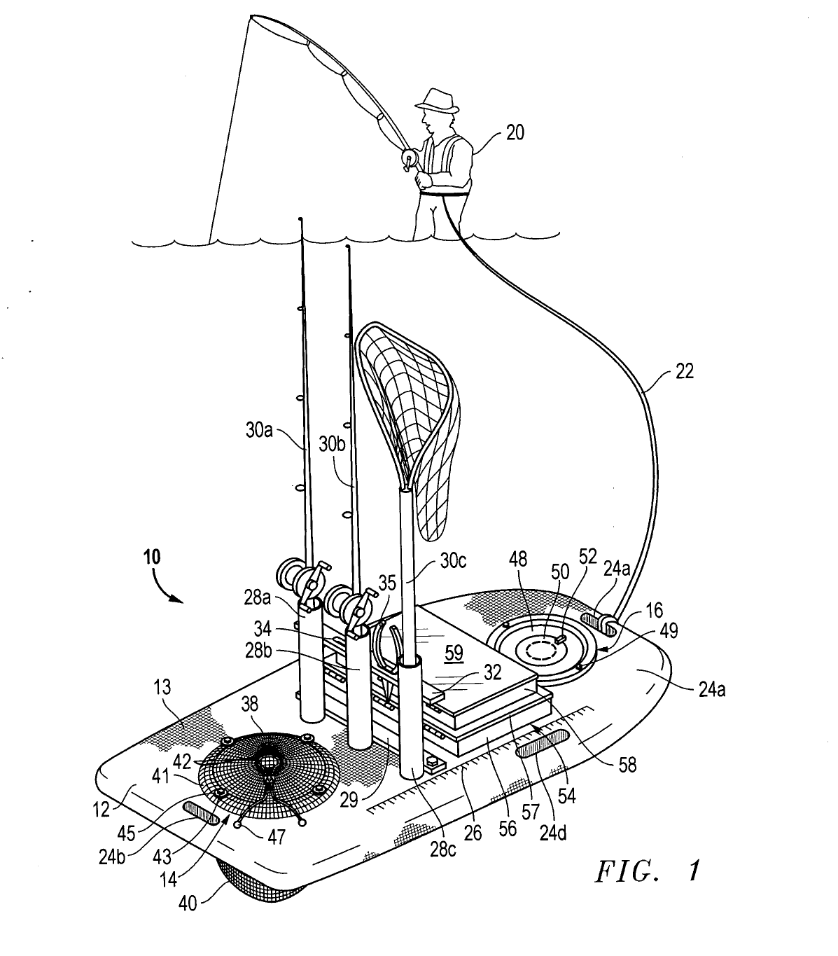

FIGS. 1-3 illustrate one embodiment of a fishing apparatus 10 according to the present invention, which has general utility in the activity of fishing, and particular utility in wade fishing which is typically conducted without a boat for carrying one's fishing gear. The fishing apparatus 10 includes a buoyant, board-like support member 12 that is light and easy to handle and exhibits a relatively large surface area. A fish container 14 is secured to the support member 12 for holding fish caught by the user. A first bait container 16 is also secured to the support member for storing bait, particularly live bait, as described further below.

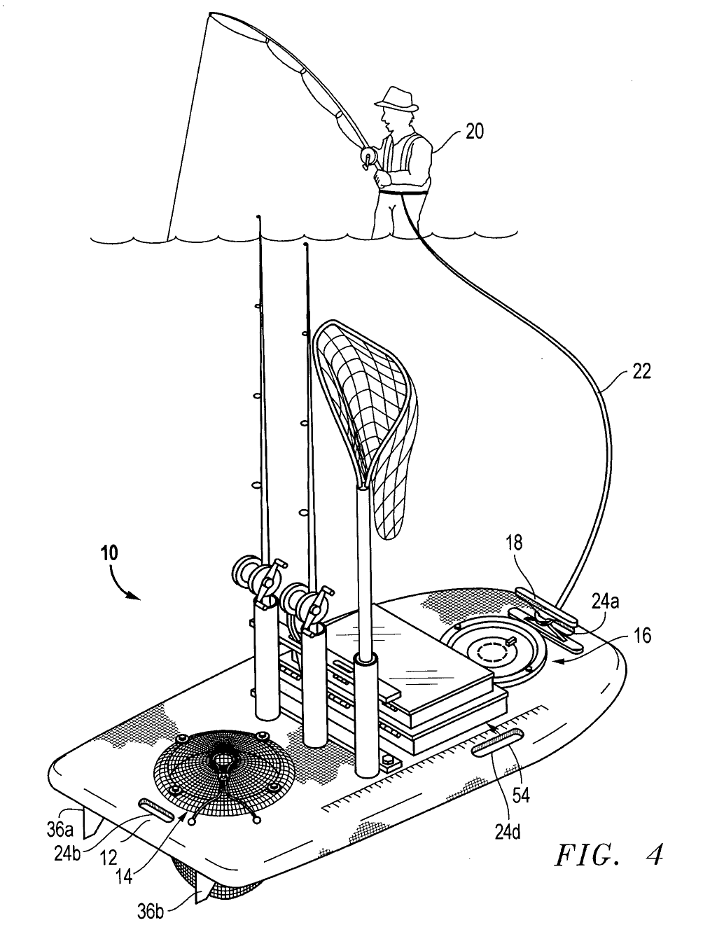

The support member 12 has an elongated securing aperture 24a therethrough for tethering to a user 20 via a tether such as a rope 22. In an alternative embodiment, shown in FIG. 4, the support member 12 also has a cleat 18 mounted thereon for tethering to a user. The tether 22 secures the fishing apparatus 10 to the user 20 by being tied at or near one of its end to the securing aperture 18a (or cleat 18b), and tied at or near the other of its ends to the user 20, e.g., around the user's waist.

The support member 12 has an outer shell formed of plastic or fiberglass, and the shell preferably has a fluorescent outer surface 13, such as by Day-Glo® pigments or paints, to provide enhanced visibility. The outer shell of the support member 12 is preferably filled with an expanded polystyrene (EPS) material, such as a Styrofoam® material, which provides buoyancy and a light weight to the support member.

The support member 12 also has at least one—and preferably four—gripping apertures 24a, 24b, 24c, and 24d extending fully through the thickness of the support member at opposing locations in the sides and forward and rear portions of the support member 12. The apertures 24a-d are sized and shaped for gripping by the hands of an adult, and one of the apertures (24a) also functions as a securing aperture for tethering to a user as described above. Alternatively, as shown in FIG. 4, the support member 12 is equipped with indentions 24a-d extending partially through the thickness of the support member. With these gripping characteristics, the inventive fishing apparatus 10 may serve as a surfacing aide for one who has stepped across a drop-off or into a hole while fishing, and as an effective life saver for someone who encounters strong surf or currents while fishing.

The fishing apparatus 10 is also equipped with measuring indicia, in the form of rule markings 26, placed along the side of the support member 12 for measuring the length of fish caught while fishing. The measuring indicia may alternatively be provided in the form of a ruler removeably affixed to the support member by a latch (not shown), so it may be conveniently stored and removed when needed to measure a prized catch.

It is also preferred that at least one, and more preferably three, fishing gear containers 28a-28c be secured to the support member 12, preferably by way of screws (not shown) securing the gear containers to a mounting bar 29 bolted to the support member 12. Each of the gear containers has a generally tubular shape and an upper open end for receiving and supporting elongated fishing gear such as fishing rods 30a, 30b and a landing net 30c. A utility bar 32 having a plurality of storage apertures 34 therethrough for receiving other fishing gear, such as pliers 35 or other hand tools, is secured to the support member 12 by way of being attached by screws (not shown) across the gear containers 28a-28c.

An optional feature of the fishing apparatus 10, shown in FIG. 4, are rudders 36a, 36b affixed to the lower surface of the support member on the sides of the fish container 14 for stability while fishing. Rudders 36a, 36b need not be particularly streamlined, since speed in the water is not a concern, and can be somewhat squared in cross-section so as to also serve as a vertical supports that complement the supporting function provided by the first bait container 16 when the fishing apparatus is out of the water and set upon a flat surface.

The support member 12 is further equipped with a fish-holding aperture 38 sized and shaped to receive the fish container 14 therethrough, whereby a portion of the fish container extends downwardly beneath the support member 12. The fish container 14 is preferably a tubularly-shaped net 40 that permits the submergence of fish disposed therein while fishing, so the fish may be kept alive and fresh for an extended period of time. The net 40 is preferably secured to the support member 12 by a toroidal mounting ring 41, bolts 43, and washers 45. The net 40 preferably has a mouth 42 that is adjustable between an open configuration and a closed configuration by means such as a draw string 47.

The support member 12 is also equipped with a circular bait-holding aperture 44 sized to receive the first bait container 16 therethrough, whereby a portion of the first bait container extends downwardly beneath the support member 12, submerging a portion of the container while fishing to keep it cooled by the water. The first bait container 16 is adapted for holding live bait, such as shrimp, and is preferably a plastic bucket 46 having a fixed lid portion 48 secured to the support member 12 by bolts 49, and an openable lid portion 50 releasably secured to the fixed lid portion 48 by a latch 52. The latch ensures the openable lid portion 50 remains shut, which is important to avoid losing live bait within the bucket 46, e.g., while wade fishing in the surf along a beach.

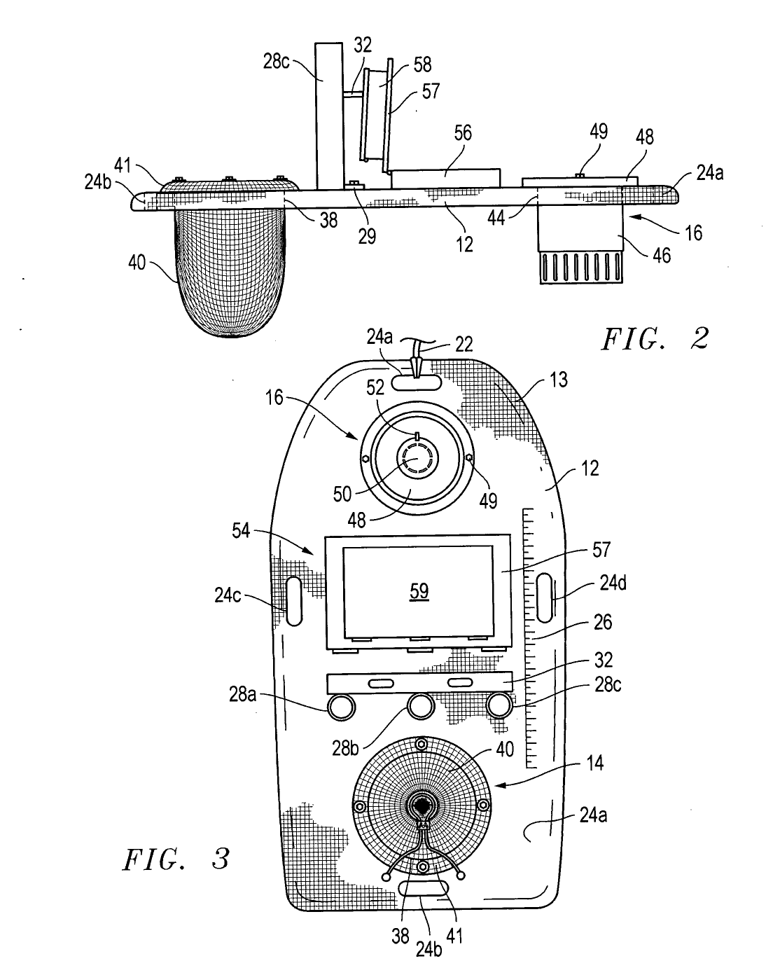

The inventive fishing apparatus 10 further include a second bait container 54 adapted for holding artificial bait, i.e., fishing lures. The second bait container is preferably secured to the upper surface of the support member 12 by screws or other similar fasteners (not shown), and includes a first plastic box 56 having an openable lid 57 and a plurality of bait-holding compartments. A second plastic box 58 having openable lid 59 is secured to the lid 57 of the first box 56, and provides additional compartments for fishing lures. The second bait container 54 is spaced apart from the gear containers 28a-c (see, e.g., FIGS. 2-3) so that the lid 57 of the first box 56 may be opened so such an extent that the second box 58 will temporarily rest against the utility bar 32 to enable easy access to the fishing lures within the first box 56.

Those having skill in the relevant art will appreciate that the inventive fishing apparatus 10 is well adapted to serve the needs of fisherman, particularly those who enjoy wade fishing. The multiple containers, compartments, and utilities of the invention obviate the need for a fisherman/woman to have a boat, or to burden his/her body, to carry and provide ready access to the various sorts of gear necessary (or desirable) to catch fish.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A fishing apparatus, comprising:
a buoyant board-like support member having at least a pair of opposing gripping apertures or indentions provided therein, the gripping apertures or indentions each being suitably shaped and oriented for hand gripping at or near respective opposing edges of the support member;
a fish container secured to the support member for holding fish; and
a first bait container secured to the support member for storing bait.

2. The fishing apparatus of claim 1, wherein the support member has a cleat mounted thereon for tethering to a user.

3. The fishing apparatus of claim 1, wherein the support member has a securing aperture therethrough for tethering to a user.

4. The fishing apparatus of claim 1, wherein the support member is filled with an expanded polystyrene material.

5. The fishing apparatus of claim 1, wherein the support member has a fluorescent outer surface.

6. (Canceled)

7. The fishing apparatus of claim 1, wherein the support member has four gripping indentations provided therein.

8. (Canceled)

9. The fishing apparatus of claim 1, wherein the support member has four gripping apertures therethrough.

10. The fishing apparatus of claim 1, further comprising a tether secured at or near one of its ends to the support member, the tether being adapted for being securing at or near the other of its ends to a user.

11. The fishing apparatus of claim 1, wherein the support member is equipped for measuring the length of a fish.

12. A fishing apparatus comprising:
a buoyant board-like support member;
a fish container secured to the support member for holding fish, the fish container being equipped with one or more apertures for passage of ambient water therethrough;
a first bait container secured to the support member for storing bait, the first bait container being equipped with one or more apertures for passage of ambient water therethrough; and
a first upright gear container secured to the support member and having a generally tubular shape for supporting elongated fishing gear.

13. The fishing apparatus of claim 12, comprising a plurality of upright gear containers secured to the support member, each of the gear containers having a generally tubular shape for supporting elongated fishing gear.

14. The fishing apparatus of claim 13, further comprising a utility bar secured to the support member, the utility bar having a plurality of storage apertures therethrough for receiving fishing gear.

15. The fishing apparatus of claim 14, comprising at least three upright gear containers secured to the support member, and wherein the utility bar is connected across the three upright gear containers at an elevation above the upper surface of the support member.

16. The fishing apparatus of claim 1, wherein the support member is equipped with at least one rudder for stability while fishing, the rudder having at least two flat sides.

17. The fishing apparatus of claim 1, wherein the support member has a fish-holding aperture sized and shaped to receive the fish container therethrough, whereby a portion of the fish container extends downwardly beneath the support member.

18. The fishing apparatus of claim 17, wherein the fish container is a generally tubular-shaped net that permits the submergence of fish disposed therein while fishing.

19. The fishing apparatus of claim 18, wherein the net has a mouth that is adjustable between an open configuration and a closed configuration.

20. The fishing apparatus of claim 1, wherein the support member has a bait-holding aperture sized and shaped to receive the first bait container therethrough, whereby a portion of the first bait container extends downwardly beneath the support member.

21. The fishing apparatus of claim 20, wherein the first bait container is adapted for holding live bait.

22. The fishing apparatus of claim 20, wherein the first bait container is substantially cylindrical and has an openable lid.

23. The fishing apparatus of claim 20, wherein the first bait container is made of plastic.

24. A fishing apparatus comprising:
a buoyant board-like support member;
a fish container secured to the support member for holding fish, the fish container being equipped with one or more apertures for passage of ambient water therethrough;
a first bait container secured to the support member for holding bait, the first bait container being equipped with one or more apertures for passage of ambient water therethrough; and
a second bait container secured to the support member.

25. The fishing apparatus of claim 24, wherein:
the first bait container is adapted for holding live bait; and
the second bait container is adapted for holding artificial bait.

26. The fishing apparatus of claim 25, wherein the second bait container is secured to the upper surface of the support member and includes at least one plastic box having an openable lid and a plurality of bait-holding compartments.

27. The fishing apparatus of claim 25, wherein the second bait container is secured to the upper surface of the support member and includes a plurality of stacked plastic boxes each having an openable lid and a plurality of bait-holding compartments.

28. A fishing apparatus, comprising:
a buoyant board-like support member;
a fish container secured to the support member and adapted for holding live fish, in the fish container being equipped with one or more apertures for passage of ambient water therethrough; and
a bait container secured to the support member and adapted for holding live bait, the bait container being equipped with one or more apertures for passage of ambient water theretrough.
